(19) United States
(12) Patent Application Publication
(10) Pub. No.: US 2002/0100710 A1
(43) Pub. Date: Aug. 1, 2002

(54) Desorbtion process and apparatus

(76) Inventor: Jim Smith Hogan, Sugar Land, TX (US)

Correspondence Address: Gregory L. Maag, P.O. Box 3267, Houston, TX, 77253-3267, US

(21) Appl. No.: 09/770,142

(22) Filed: Jan. 26, 2001

(51) Int. Cl. C10G 1/00; F27B 7/36

(52) U.S. Cl. 208/13; 208/187; 585/240; 202/105; 202/136

(57) ABSTRACT

A method and apparatus for desorbtion is disclosed that utilizes enhancements to lessen the amount of entrained particles formed during desorbtion and for lowering the operating and capital costs associated with desorbtion equipment. Multiple stage desorbtion is contemplated using multiple drums, with smaller drums being employed for volatizing the waste components that require high temperatures. The method and apparatus may include an eductor scrubber attached directly or adjacent to the gas extraction port of a drum to prevent fouling of system apparatus. A plunger for cleaning the scrubber suction chamber is provided. The method and process may include injecting hot gas, which may be exhaust gas from a burner apparatus, into one or more desorption drums to lower heating costs.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates to the processing of organic waste material for the removal and recovery of hazardous and useful materials by non-oxidative thermal distillation and decomposition. In particular, the invention relates to the vaporization and removal of liquids, in a sealed rotating drum, from solid waste material. More particularly, the invention relates to improved methods and apparatus for efficiently removing water and hydrocarbons by vaporization from solid waste material through desorption, at lower cost, and without entraining a high volume of solid particulates in the vapors removed.

2. Background of the Invention

Industrial waste contains a large variety of components, many of which are organic in composition. Some industrial waste contains material that is classified as hazardous and presents a disposal problem. However, many industrial waste materials also contain useful products, which, if recovered, can be sold or reused to increase the profitability or efficiency of the original process. Therefore, the treatment of industrial waste is desirable in order to separate the useful products from the hazardous or non-useful material.

Reaction vessels and processes for the thermal desorbtion and separation of waste material are known in the art. Many different methods and apparatus are known and used. One of the more successful methods involves treating the waste in a rotating drum, commonly called a “desorber.” The use of rotating drums to convey waste materials while using heat to modify such materials, either chemically or physically, is also known in the art. Examples of such methods and apparatus may be found, for example, in U.S. Pat. Nos. 4,872,954; 5,078,836; 5,227,026; 5,523,060; 5,851,361 and 5,961,870, the disclosures of which are incorporated herein by reference.

These methods and apparatus are primarily concerned with heating the waste material and vaporizing the liquid material in a sealed rotating drum. The rotating drum is generally heated indirectly via an external heat source causing hot gas to circulate around the drum. The heat vaporizes the low boiling liquids and cracks the desired high boiling hydrocarbons, effectively separating the vapor from the bulk solid material. The vapors and solids are removed from the drum separately.

A drawback to these current processes is that the waste material usually contains a large volume of water and volatile hydrocarbons, creating a corresponding large volume of vapor. For example, “tank bottoms” may consist of about 50% water, 30% oil and 20% solids, and may include high molecular weight hydrocarbons and inorganic materials, such as common dirt. Since the waste material must be heated to a very high temperature in order to crack and vaporize the high boiling hydrocarbons, a very fine dust is formed. This very fine dust is especially susceptible to becoming entrained in the large volume of vapors that is found in the process.

Although, very fine, the entrained solid particulates create a “dirty” oil/hydrocarbon effluent stream, which increases the cost and amount of effort needed to clean the oil/hydrocarbon products. In addition, the solid particulates naturally deposit within the system during the treatment process, causing fouling of the lines, coolers, and any other operating equipment that may lie downstream of the desorption drum. This is especially troublesome when it occurs in the drum's initial vapor removal line, where a clog can cause a dangerous buildup of gas and pressure within the drum.

Additionally, because of the very high temperatures to which conventional desorbor drums are heated, the alloys from which the drums are manufactured must be able to withstand such extreme temperatures. Such alloys are very costly and, given that desorbtion drums may be approximately 4 to 8 feet in diameter and 20 to 80 feet long, the cost of such drums is very substantial and represents a sizeable percentage of the total capital cost associated with manufacturing and installing a desorbtion unit.

A need therefore exists for an improved method and apparatus for the processing of such industrial waste materials and the efficient removal of the small, entrained particulates from the vapors of said waste. It is also desirable that a means be found to substantially decrease the amount of expensive alloy that must be employed in the desorbtion drums and system, and to lower the substantial costs associated with heating the waste material.

### BRIEF SUMMARY OF THE INVENTION

The problems and deficiencies noted above are solved in large part by the present invention of an improved method and apparatus for the non-oxidative, thermal decomposition of nongaseous, heat-dissociable organic matter into a solid residue and a mixture of gaseous products. The invention can be employed to minimize entrained particulates and the problems they create by employing a contiguous series of heated, rotating drums operating at different parameters.

In general, each drum operates by separating the waste material in to a gas and a solid material. Waste is moved into the interior of each rotatable drum via a non-rotatable first bulkhead attached to the inlet end of each drum. The non-rotating first bulkhead is connected to the inlet end of each drum to seal the inside of the heating drum. Once inside the drums, the waste is heated. A heating medium may be circulated about the exterior surface of the drum, or hot gas may be inserted into the drum, or both methods may be used. Where a burner is employed to heat the exterior drum surfaces, it is preferred that the exhaust gas that is generated be collected and thereafter conveyed into the interior of one or more of the desorber drums to provide additional heating. This lowers the overall heating costs associated with the desorbtion process.

During heating, the drums are preferably deprived of oxygen so that the thermal distillation, decomposition or cracking of the volatile material is conducted in a non-oxidative mechanism. Thus, an inert gas is preferably introduced into each drum to create a substantially oxygen-free atmosphere.

The heat vaporizes the liquid components of the waste material to produce a vapor effluent and a solid effluent. A non-rotational second bulkhead is connected to the outlet end of the drum and seals the inside of the drum from the outside. The processed solid residue flows out of the drum through a conduit that is connected to the inside of the drum through the second bulkhead.

Several features of the present invention are related to the reduction of entrained particulates in the vapor effluent and to the operation of the desorber system in an efficient manner without fouling of the components. Depending on the waste material being processed and the purpose of each particular process, each of the various features may be employed independently or in combination. The most preferred embodiment is to incorporate all features in combination to minimize the amount of entrained particulates and thus to minimize fouling of the system.

Accordingly, process and apparatus are provided for vaporizing and removing the larger quantity of volatile materials in a first heating drum that operates at a lower temperature and where the majority of the fine particles are not formed. The solids removed from the first drum are conveyed into a second heating drum as part of a continuous process. The second drum is employed to vaporize and remove the smaller quantity of volatile material at a higher temperature. It is at the higher temperatures where the majority of the fine particulates are formed. Thus, by removing particulates with the smaller quantity of vapors from the second heating drum, less processing of the effluent is required, leading to increased efficiency and lower operating costs. Additional drums may also be provided for further reduction of particulates in the vapors and heating the waste material to an even higher temperature, for removal of higher boiling hydrocarbons.

In a preferred embodiment, an ejector-venturi gas scrubber, called eductor scrubber hereinafter, is selectively connected to either the first or second non-rotating bulkhead of each drum. The vapor effluent evacuates the drum by escaping selectively through the first or second bulkhead as influenced by the connected eductor scrubber. The high velocity of the liquid in the eductor scrubber creates a draft that draws the vapors from the rotating drum and reduces the amount of entrained particulates by knocking them out of the vapor.

Although the present invention will produce a significantly reduced amount of entrained particulates, some particulates will nevertheless remain in the exiting vapors. As vapors exit a heating drum through the suction inlet of the attached eductor scrubber, some deposition of the particulates will occur. The particulates may collect over time to eventually foul or plug the suction chamber of the eductor scrubber. The present invention provides for cleaning of the suction chamber without shutting down or otherwise disrupting the operation of the drum. The cleaning is accomplished via a plunger that is sealably and slideably located in the suction chamber.

In the preferred embodiment, the chamber is basically a cylinder with a plunger disposed therein. The plunger includes a cylindrical cross section sized to engage the walls of the chamber. The plunger may be manipulated either manually or by automation to move axially along the chamber, essentially scraping the buildup of particulates off of the walls of the chamber. The plunger's outer surface may selectively have various configurations, such as saw teeth, to assist in removing the solid buildup from the chamber. In addition, the plunger may rotate as it is moved along the chamber to assist in the removing of the solids from the chamber. In the preferred embodiment, the chamber is relatively small, allowing the procedure to be performed within a minute.

Both the structural features of the apparatus and the steps of the process are more fully understood by reference to the attached drawings and upon consideration of the more detailed description of the preferred embodiments described hereinafter.

### BRIEF DESCRIPTION OF THE DRAWINGS

For a detailed description of the preferred embodiments of the invention, reference will now be made to the accompanying drawings in which:

FIG. 1 schematically shows a preferred embodiment for a single stage desorbtion apparatus of the present invention.

FIG. 2 schematically shows a preferred embodiment for the second stage of a two stage desorbtion apparatus of the present invention;

FIG. 3 schematically shows a preferred embodiment for the second stage of a three stage desorbtion apparatus of the present invention;

FIG. 4 schematically shows a preferred embodiment for the third stage of a three stage desorbtion apparatus of the present invention;

FIG. 5 schematically shows a preferred embodiment for a solids cooling apparatus of the present invention; and

FIG. 6 schematically shows a preferred embodiment for an eductor scrubber of the present invention;

FIG. 7 schematically shows another preferred embodiment for an eductor scrubber having a cleaning apparatus of the present invention;

FIG. 8A shows a typical screw conveyor that is suitable for use in the present invention;

FIG. 8B shows a preferred embodiment for a screw conveyor suitable for use in the present invention where the screw conveyor is employed as a vapor seal; and

FIG. 8C shows another preferred embodiment for a screw conveyor suitable for use in the present invention on employed as a vapor seal.

FIG. 9 is a side view of a piston apparatus of the eductor scrubber shown in FIG. 7.

FIG. 10 is a partial cross sectional view of a desorber drum made in accordance with one embodiment of the invention.

### DETAILED DESCRIPTION OF PREFERRED EMBODIMENTS

In the description that follows, like parts are marked throughout the specification and drawings with the same reference numerals. The drawing figures are not necessarily to scale. Certain features of the preferred embodiments may be shown in exaggerated scale or in schematic form, and some details of conventional elements may not be shown in the interest of clarity and conciseness.

The present invention is directed to four principal areas namely: 1) methods and apparatus for staging desorbtion of volatile material from waste; 2) methods and apparatus for the recovery of hydrocarbons and/or water while minimizing the amounts of entrained particles; 3) methods and apparatus for retorting waste material without producing significant volumes of “entrainable” particles; and 4) methods and apparatus for removing entrained particles from the effluent and process equipment. Viewed as a whole, these principal areas provide a method and apparatus for a more efficient and cost effective desorbtion process. The present invention may be carried out in different forms. The drawings and the corresponding written description detail specific embodiments of the present invention. However, it is to be understood that the present disclosure is intended merely to exemplify of the principles of the invention, and is not intended to limit the invention to the specific embodiment illustrated and described herein.

The present invention is directed in general toward treating waste material in such a way as to prevent a significant amount of particles from becoming entrained in volatile effluents and to keep those particles that do become entrained from disadvantaging the process and/or apparatus to a significant degree. This can be achieved by: creating fewer entrainable particles; using methods that do not “pick up” or entrain significant amounts of particles; using methods or apparatus that more effectively deals with entrained particles; or combinations thereof. Thus, several methods and apparatus are described herein that accomplish these goals. The various teachings and combinations can be used independently or in combination as necessary or desired for a particular application or to product a particular result. It is to be fully recognized that the different teachings of the embodiments discussed below may be employed separately or in any suitable combination to produce desired results.

One embodiment involves using a multiple stage desorbtion process. As used herein, a “stage” refers to a particular treatment of the waste material as it flows through the system. The number of stages is determined by the type or makeup of the waste material, economic factors, operator preference or some combination thereof. In a first preferred embodiment, a multiple stage desorbtion process in accordance with the present invention would involve three contiguous desorbtion stages. The multiple stage desorbtion process is advantageous in various respects. For example, the temperatures of the stages can be selected such that, by the time the solid waste begins to form the undesirable entrainable particles, most of the volatile material has already been desorbed. Thus, at high temperatures, where most of the entrainable particles are formed, only a very small volume of vapor is produced, which can carry only a correspondingly small amount of particles out of the desorber drum.

In addition, there are cost advantages to building and operating desorbtion drums at different temperatures. For example, drums heated only to lower temperatures need not be made of expensive alloys that are capable of withstanding the higher temperatures, and do not require higher energy costs to produce the necessary heat. Drums that are to be heated to higher temperatures can be manufactured significantly smaller in size due to the reduced volume of volatile material that will be passed into the drum, given that a significant volume have already been removed from a prior drum during a prior stage of the desorbtion process. Although higher temperatures require the use of more expensive alloys for the drum, the amount of the expensive alloy needed is significantly reduced because of the drum's smaller size.

Alternatively, or in combination with a multiple stage desorbtion process, an eductor scrubber can be attached or positioned directly adjacent to one or more of the desorbtion drums in order to facilitate the removal of any entrained particles. The attached or adjacent eductor scrubber increases the efficiency for separation and recovery of volatile material from entrained particles with respect to the particular desorbtion drum to which the scrubber corresponds. For certain waste materials or applications, providing the adjacent eductor scrubber may provide enough “cleaning” of the volatile material such that a single stage desorbtion apparatus produces satisfactory results.

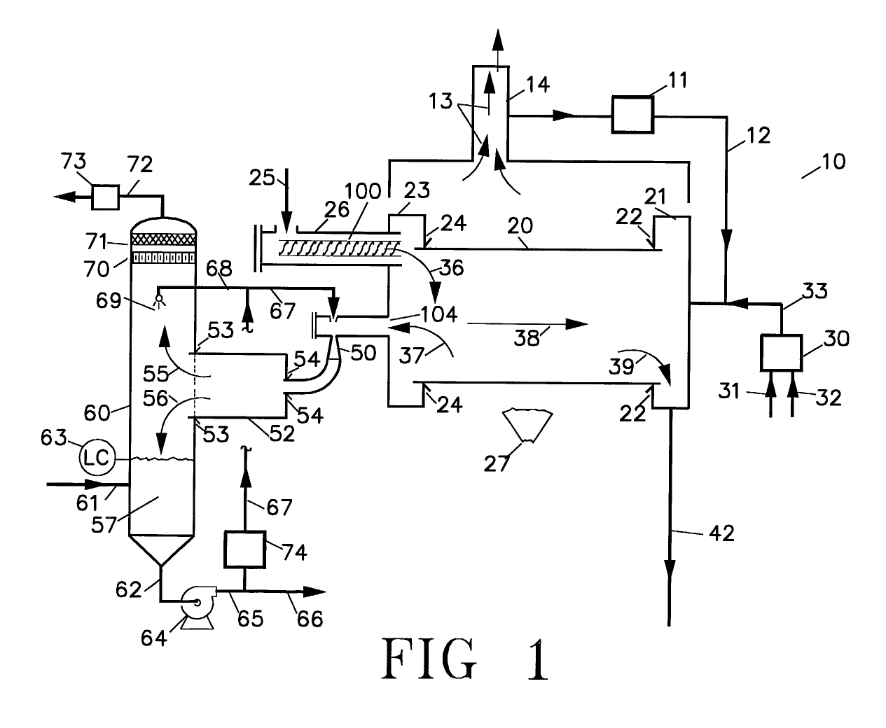

Reference is now made to FIG. 1 of the drawings wherein, a single stage desorbtion apparatus 10 is shown including a rotatable heating drum 20. Drum 20 is connected to nonrotatable inlet bulkhead 23 at seal 24 and non-rotatable outlet bulkhead 21 at seal 22. Drum 20 is heated by burner apparatus 27. Seals 22 and 24 seal the inside of drum 20, preventing oxygen from entering the drum and preventing gases formed during the desorbtion process from escaping the drum. Drum 20, bulkheads 21, 23, seals 22, 24 and burner 27 sometimes may be collectively referred to below as the drum-bulkhead assembly. Waste to be treated is fed from a storage container or hopper (not shown) into conduit 26, as indicated by arrow 25. Such waste may be any of a variety of waste products, such as waste oil sluges, tank bottoms, oil-ladened soils, other refinery waste, spent catalyst, drilling fluids and other material. Conduit 26 preferably contains a screw conveyor 100 that conveys the waste through conduit 26 and into drum 20 as indicated by arrow 36. Once inside drum 20 the waste material is conveyed through the drum in accordance with arrow 38 as explained in more detail below.

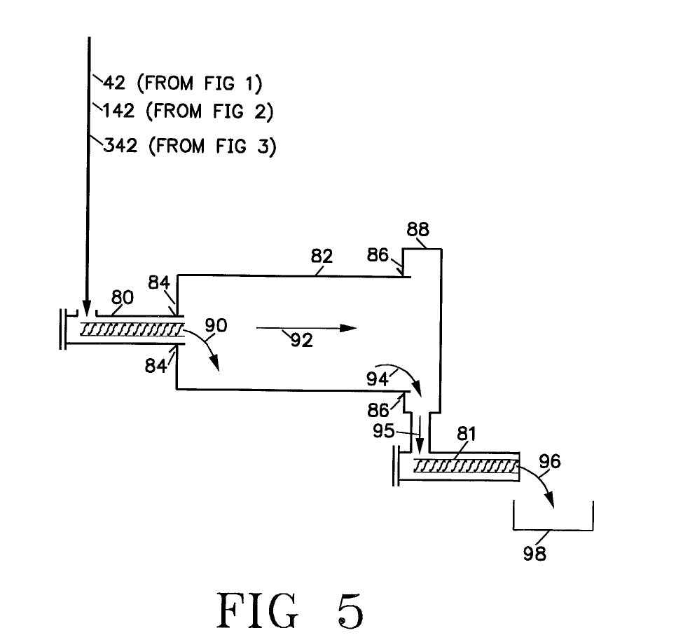

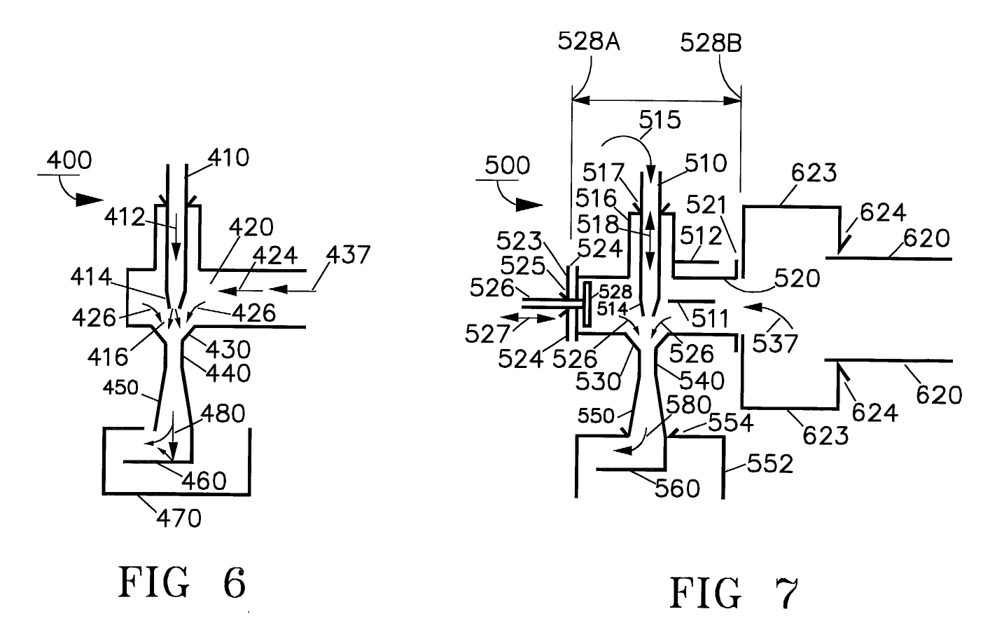

The waste material is heated as it is moved through drum 20. As the waste is heated, the volatile material is vaporized and the vapors flow out of drum 20 through bulkhead 23 via aperture or extraction port 104. In an alternative embodiment, port 104 would lead to a vapor removal line (not shown) that takes the vapor to accumulator 60 directly or through a series of cleaning and condensing steps to purify and/or separate and/or collect the effluent as desired. However, in the preferred embodiment of FIG. 1, the vapor is drawn from extraction port 104 into an eductor scrubber 50 in accordance with arrow 37. The eductor scrubber 50 of the preferred embodiments is an Ejector-Venturi type gas scrubber. Such eductor scrubbers are well known in the industry as having a gas inlet, leading into a suction chamber, a scrubbing or motive fluid inlet, a jet or nozzle for introducing the motive fluid, and a diffuser. In general, the motive fluid is sprayed toward a conveying diffuser section or “outlet.” The flow of the motive fluid lowers the pressure in the suction chamber. These conditions create a draft of the vapors from the desorber drum into the suction chamber, through the diffuser and ultimately to the accumulator. Eductor scrubbers suitable for use in the present invention are described in more detail below with reference to FIGS. 6 and 7. The gas inlet of eductor scrubber 50 is preferably connected directly to the drum bulkhead assembly as at extraction port 104. However, the gas inlet to the eductor scrubber may be positioned a short distance from the drum bulkhead assembly as desired or necessary to provide clearance or other reasons. Accordingly, as used in this description and in the claims which follow, the term “adjacent” when used to describe the location of the eductor scrubber in relation to the desorber drum means that the gas inlet to the suction chamber of the eductor scrubber is attached directly to the extraction port of the drum or is located at any location between the port and the accumulator.

As shown in FIG. 1, eductor scrubber 50 is connected to a rotatable cooling drum 52 by seal 54. Eductor scrubber 50 creates a draft that draws the vapors from drum 20. This impacts and entrains the particulates in the vapor and discharges the vapors, liquids, and entrained particulates into rotatable cooling drum 52.

Rotatable cooling drum 52 is exposed to outside ambient conditions and cools by conduction the vapors and liquids that are conveyed through it. Additional cold air or water may optionally be caused to flow over the external surface of cooling drum 52 to enhance or assist in cooling. Drum 52 is attached to non-rotatable accumulator 60 by seal 53, and the cooled vapors and condensed liquid flows out of drum 52 into accumulator 60 in accordance with arrows 55 and 56 respectively. Alternatively, cooling drum 52 may be maintained at a preselected temperature to prevent certain hydrocarbons from condensing.

The vapors flow out of accumulator 60 through plate scrubber 70, mesh separator 71, and outlet pipe 72. Plate scrubber 70 and mesh separator 71 are commonly used devices and well known by those of ordinary skill in the art. Blower 73 is used, if required, to assist in removing the vapors. The vapors are then passed to a thermal oxidizer, an additional cooler, or other processing equipment (none shown) as desired or required for a particular application. Plate scrubber 70, mesh separator 71 and blower 73 are all optional and are only used if required for a particular desired application.

The condensed liquid 56 collects in the bottom of accumulator 60, as shown by 57. Condenstate 57 is pumped from accumulator 60 by pump 64 to scrubber 50 through pipes 62, 67. Pipe 67 is the feed line for the motive fluid that is used in scrubber 50. A side stream of liquid from line 67 may be diverted through line 68 to spray nozzle 69 and used for additional temperature control and cleaning of the vapors in accumulator 60, as described in more detail below. It should be appreciated that in alternative embodiments, where a scrubber is not directly attached or positioned adjacent to a desorbtion drum-bulkhead assembly, line 67 may still feed accumulator 60 via line 68 and may also be used to feed other components where a liquid stream is needed.

A controlled amount of condensate 57 is allowed to flow out of accumulator 60 via line 62 and through side stream pipe 66. The particulates in this side stream liquid in pipe 66 are separated by gravity, filter press, centrifuge, or other conventional means (not shown). Make up clean liquid may be added to accumulator 60 by pipe 61, as may be required from time to time to replace the dirtier liquid removed through pipe 66, thereby keeping the condensate 57 relatively clean. The makeup clean liquid may come from a variety of sources, including liquid from downstream of line 66 after the liquid has undergone sufficient processing as previously described. The liquid level in accumulator 60 may be controlled by level controller 63, which controls the flow rate through line 61. Level controllers, such as controller 63, are common in the industry and well known to those of ordinary skill in the art. Level controller 63 may be any type of controller, including mechanical or electronic, and it may be computer aided.

The operating temperature of accumulator 60, and type of liquid used for the motive fluid for scrubber 50, depend on the targeted liquids that are intended to be recovered from the vapors created in drum 20. If accumulator 60 and eductor scrubber 50 are operating on a drum of a desorber apparatus treating a waste that has a substantial quantity of water, and if the water is to be recovered for treatment in a water treatment facility, then the accumulator should be operated at less than 212° F. at ambient pressure, and the motive fluid in the eductor scrubber should be water. If treating the same waste material, but where it is not desired to condense the water, oil should be the scrubber's motive fluid, and the temperature in the accumulators should be maintained above 212° F. at ambient pressure. On the other hand, when the vapors drawn from drum 20 contain very little water, oil may be the motive fluid. Of course, if no separation of the vapor fractions is desired, the temperature in accumulator 60 should be as low as economically possible in order to recover as much oil as possible. It will be appreciated that in the situation where there is very little water in the vapors removed from drum 20, the temperature in the vapor recovery components (i.e., motive fluid in the scrubber, the cooling drum and the accumulator) can be manipulated to separate heavy oil from light oil. As the temperature is increased, only those hydrocarbons whose boiling points are below that temperature will condense.

Additional cooling or heating means 74 may be optionally employed in line 67 to help control the temperature of accumulator 60 and/or the motive fluid for eductor scrubber 50. The size of cooling drum 52 may be decreased or completely omitted, if accumulator 60 is to be operated at a high temperature.

Referring still to FIG. 1, the heated solids are conveyed out of drum 20, in accordance with arrow 39, through bulkhead 21, and pipe 42, for further processing. Flow of the waste material through drum 20 can be achieved by any of the methods known in the industry, preferably those methods described herein and included in patents previously incorporated herein. For example, the material can be moved by sloping the drum and letting the material flow by gravity, or by some freely rotatable apparatus, as taught by U.S. Pat. No. 5,078,836, or by fixed mechanical means, or any combination thereof. If drum 20 is to be used as a single stage desorber, the solids in pipe 42 will be conveyed to the solids cooling apparatus illustrated in FIG. 5.

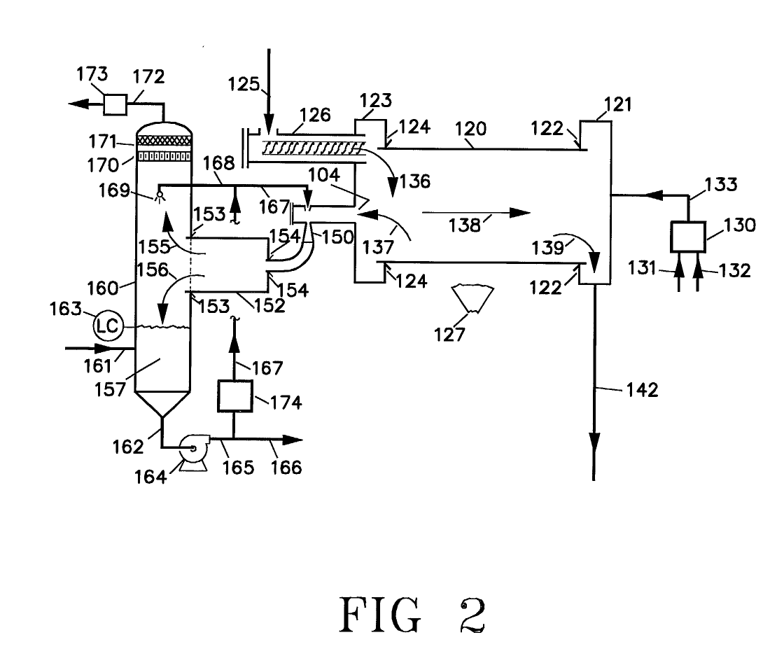

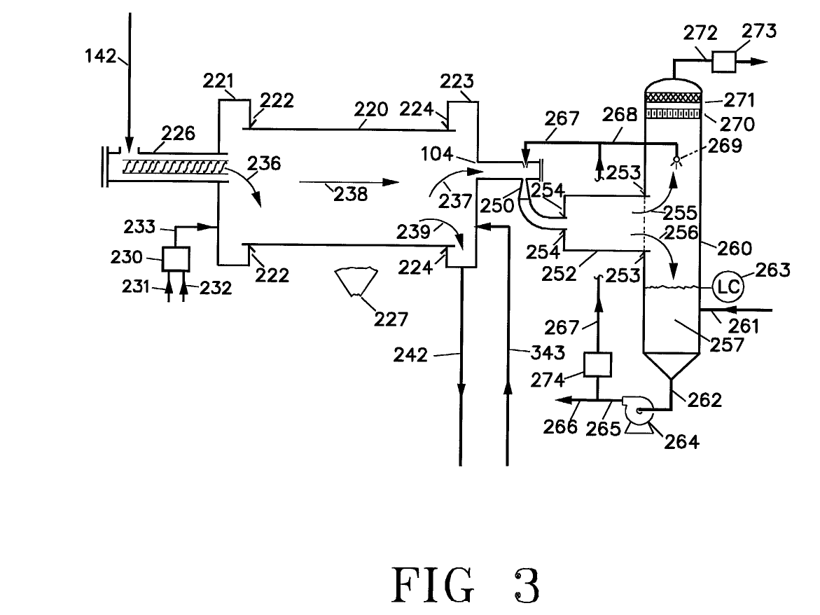

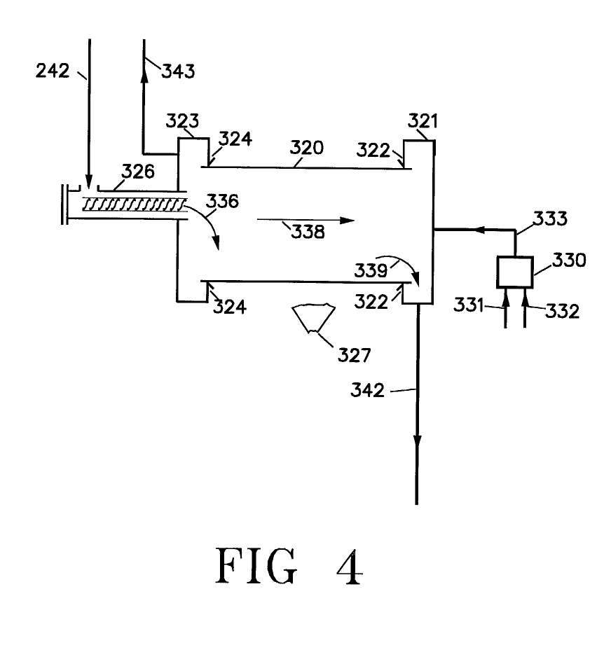

If drum 20 is to be used as the first stage of a two stage desorber, the solids in pipe 42 are conveyed to the second stage apparatus (FIG. 2) and then to the solids cooling apparatus of FIG. 5. And, if drum 20 is to be used as the first stage of a three stage desorber, the solids in pipe 42 are conveyed to the second stage, as shown in FIG. 3, then to the third stage, shown in FIG. 4, and then to the solids cooling apparatus of FIG. 5. Multiple stage desorbtion, according to the present invention, is preferably carried out as a continuous process. For example, solid material should flow directly from one stage to the next via some conduit or other connecting pathway. Thus, the apparatus for multiple stage desorbtion is a contiguous series of desorbtion units that could be viewed as a single apparatus.

As shown in FIG. 1, drum 20 is heated by external burner 27. Burner 27 applies flame or radiant heat directly on the drum exterior as described in the references incorporated herein, such as U.S. Pat. No. 5,523,060. However, it is sometimes desirable to add heat on the inside of the drum. In most cases, because the organic waste may not be incinerated due to environmental regulations, excess oxygen is not permitted inside of drum 20. One embodiment for adding internal heat without adding oxygen is by applying microwaves to the inside of drum 20, as taught by U.S. Pat. No. 5,961,870, which is hereby incorporated by reference.

Referring again to FIG. 1, heat is added on the inside of drum 20 by flowing a hot inert gas, containing substantially no oxygen, through drum 20 via hot gas inlet line 33. This gas can be generated by a conventional hot gas generator 30. In the preferred embodiment, the flame in generator 30 is powered by a stoichiometric mixture of fuel from line 31, and oxygen, or air, from line 32. Generator 30 is controlled such that the hot gasses from the flame contains substantially no excess oxygen. This can easily be accomplished with modern day burners and the procedure is well known by those familiar with the art. This is also taught by U.S. Pat. No. 5,851,361, which is hereby incorporated by reference. This internal heat can be supplemental to heat supplied by burner 27, or it can completely replace burner 27.

As an alternative to a hot gas generator, exhaust gas resulting from burner 27 may be employed. More particularly, as burner unit 27 heats the exterior of drum 20, exhaust gases, represented by arrows 13 are collected and discharged via stack 14. These exhaust gases, or some portion thereof, may be collected in stack 14 and conveyed via flow control valve 11 and line 12 into hot gas inlet line 33. The use of flow control valve 11 is optional depending primarily on the discretion and needs of the operator. Since eductor 50 and/or optional blower 73 operate to create a vacuum in drum 20, the hot gas from line 12 will automatically be drafted into drum 20. In this manner, exhaust gases from burner 27 may supplement the gas produced by hot gas generator 30 or may supplant it such that no hot gas generator 30 is required.

There are several advantages to heating only by the addition of hot gas inside drum 20. First, when drum 20 is operated at a higher temperatures, i.e., 1000° F. to 2000° F., drum 20 can be insulated on the inside, thereby allowing the majority of drum 20 to be manufactured at a lower cost from a less expensive alloy material. More specifically, and referring momentarily to FIG. 10, only an inner skin or sleeve portion 15 of the drum 20 would need to withstand the intense temperatures, while the outer sleeve portion 16 of the drum could be made from a less costly material that would not be subjected to such extreme temperatures. Further, heating drum 20 from the inside requires less fuel, and thus lowers operating costs as compared with externally heating the drum via burner 27.

Drum 20 in FIG. 1 operates at a preselected temperature that depends on the composition of the waste material being processed and the desired liquids to be vaporized from the waste. When employed as a single stage desorber, the temperature in drum 20 must be high enough to vaporize all of the volatile material desired to be removed. To vaporize the water in the waste, at ambient pressure, the temperature of drum 20 must be higher than 212° F. About 450° F. is a typical temperature to operate drum 20 as a dehydrator. Temperatures necessary to remove the remaining hydrocarbons will depend on the composition of the waste material. Operational temperatures below about 800° F. to 1000° F. can minimize the formation of fine dust particles.

Reference is now made to FIG. 5 of the drawings that schematically shows a solids cooling apparatus of the present invention. The solids cooling apparatus can be employed with a single, two, or three-stage desorber. Of course, there are other ways to cool desorber solids, but the apparatus described with reference to FIG. 5 is presently preferred. As shown, solids are received by screw conveyor 80 from line 42 from the apparatus of FIG. 1. The solids flow from conveyor 80 to cooling drum 82, as shown by arrow 90. Cooling drum 82 is a sealed rotating drum, and the inlet is sealed from non-rotating housing of screw conveyor 80 by seal 84 and the outlet is sealed from non-rotating bulkhead 88 by seal 86. Cooling drum 82 is exposed to outside ambient conditions and therefore the exterior of the cooling drum 82 is cooled by conduction and radiation, and the solids inside the drum are cooled by conduction. Additional cold air and/or water can be caused to pass over the exterior of drum 82, if desired, to provide additional cooling. The solids flow through drum 82 as indicated by arrow 92, to bulkhead 88, and out of bulkhead 99 as indicated by arrow 94. The solids then pass to screw conveyor 81, as indicated by arrow 95, and to container 98, as indicated by arrow 96. Screw conveyor 80 serves as a vapor seal between drum 82 and its inlet, and screw conveyor 81 serves as a vapor seal between drum 82 and its outlet, thereby preventing additional vapors from entering or leaving drum 82.

Eductor scrubber 50 was previously described with reference to FIG. 1. FIGS. 6 and 7 illustrate preferred eductor scrubbers for use in accordance with the present invention.

Referring first to FIG. 6, eductor 400 generally includes a motive conduit 410, nozzle 414, suction chamber 420, conversing diffuser section 430, mixing chamber 440 and expanding diffuser section 450. The pressurized motive fluid enters the suction chamber 420 through motive conduit 410 and flows in accordance with arrow 412. The fluid flows through nozzle 414 which causes the entering motive fluid to accelerate as it passes through the converging portion of nozzle 414 and exits the nozzle as shown by arrows 416. Nozzle 414 is of the converging type if the motive fluid is a liquid, or of the expanding type if the motive fluid is steam or another gas.

The suction chamber 420 is where the pumping takes place. The vapor or “suction media” from the desorbtion or drum 20 (FIG. 1) enters suction chamber 420 at suction chamber inlet 437 and flows through the suction chamber 420 as indicated by arrow 424. As the accelerated motive fluid leaves the nozzle 414, as indicated by 416, the friction between it and the suction media in the suction chamber 420 forces the mixture into the converging diffuser section 430, lowering the pressure in suction chamber 420 and drawing additional suction media from the suction inlet 437. This arrangement creates a draft that accelerates the removal of effluent vapor from the desorbtion drum 20 in accordance with arrow 437. The motive fluid entrains the suction media and uniformly mixes the combined stream in the mixing chamber 440. The expanding diffuser section 450 is specially shaped to reduce the velocity of the combined mixture, converting the kinetic energy to pressure at discharge. A baffle guide 460 is disposed at the end of diffuser section 450 to allow the mixture to impinge against guide 460, further entraining the suction media, and directing the mixture out to the side of container 470, as shown by arrow 480.

Referring now to FIG. 7, there is shown another eductor scrubber 500 that is suitable for the present invention. Eductor scrubber 500 includes suction chamber 520 and a piston or plunger 528, described in more detail below, as a means to scrape and thereby clean suction chamber 520. As shown, eductor scrubber 500 is attached to drum 620, which is identical to drum 20 previously described. Seal 624 seals between rotating drum 620 and non-rotatable bulkhead 623. Eductor scrubber 500 is connected to bulkhead 623 at seal 521. Eductor scrubber 500 has a motive inlet conduit 510, nozzle 514, suction chamber 520 with suction 537, converging diffuser section 530, mixing chamber 540, expanding diffuser section 550, and baffle guide 560, all as shown in FIG. 7 . Suction chamber 520 is joined to side chamber 516 that is attached to motive inlet conduit 510 at seal 517. Conduit 510 is connected to flexible tube 515 such that nozzle 514 can be moved from position 511 to position 512. Seal 517 slidingly seals between inlet conduit 510 and side chamber 516. Flange 523 is connected to chamber 520 at connection 524. Plunger 528 is connected to actuator rod 526 which extends through flange 523 at seal 525 such that rod 526 is allowed to reciprocate through seal 525 as indicated by arrow 527. The movement of rod 526 also moves plunger 528 to clean the inside of chamber 520. The plunger mechanism may be moved manually or by hydraulic, electro mechanical, electronic or computer aided means.

Referring still to FIG. 7, the vapors that enter suction inlet 520, particularly from a single stage desorber drum 620, are sometimes so laden with particulates that the particulates collect on the walls of chamber 520 and eventually foul and plug chamber 520. Even with low particulate effluent from early stages of a multiple stage desorbtions process, the particulates can, over time, collect on the walls until they reach a point that the accumulation becomes dangerous or limiting to the process. The eductor scrubber 500 allows the cleaning of chamber 520, without shutting down the operation of drum 620. This can be easily accomplished in a minute or so according to the following procedure: a) turn off the pressurized motive fluid and move conduit 510 such that nozzle 514 moves from position 511 to position 512; b) move plunger 528 from position 528A to position 528B and back to position 528A to clean chamber 520; and c) return nozzle 514 back to position 511 and turn on the pressurized motive fluid.

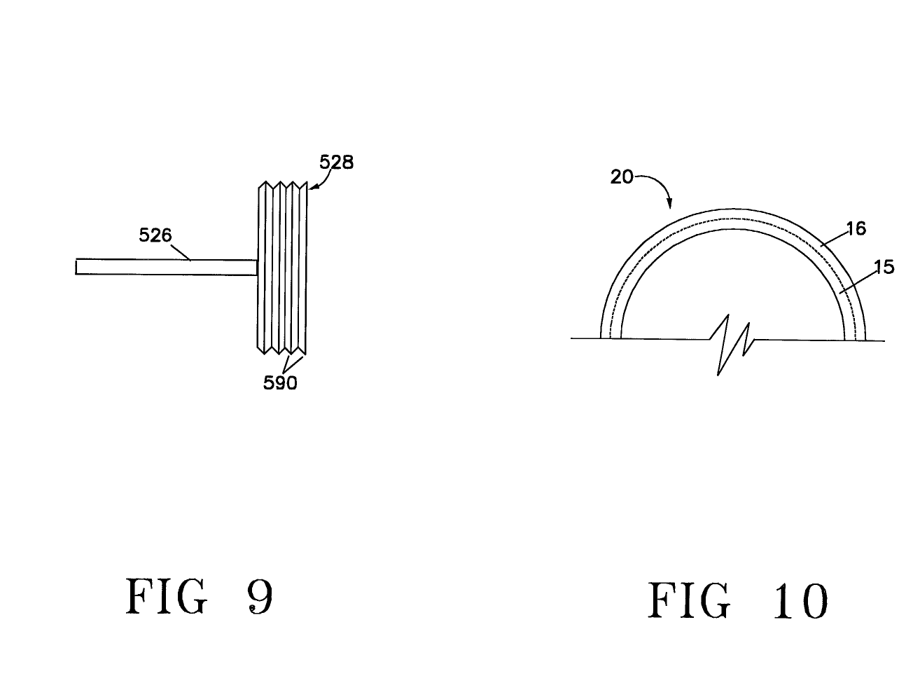

The shape of the plunger's face should correspond and be “congruent” to the cross sectional shape of the eductor scrubber's suction chamber 520. By this it is meant that the plunger face should be sized and shaped to closely match the size and shape of the suction chamber's inner surface such that the plunger's perimeter or side surface has only a slight clearance with the inner walls of chamber 520. Thus, when plunger 528 is moved between positions 528A and 528B and back, deposits on the walls will be removed or cleaned by the side surface of plunger face as it scrapes the deposits from the chamber walls as it reciprocates within the chamber. As shown in FIG. 9, plunger 528 can be manufactured to have saw teeth or file-like ridges 590 or some other configuration around the face's perimeter to assist in removing solids from the inner walls of chamber 520. Although any shape is possible, a circular inner chamber cross-section is preferred. A circular shaped plunger has the advantage of being capable of being rotated as it is moved from position 528A to position 528B and back. It can also be seen that accuator rod 526 and tube 510 can be moved by an automatic power source, not shown, and that the entire cleaning procedure can be done automatically, either at specified times or designated intervals, or as necessary or as determined by a detection means.

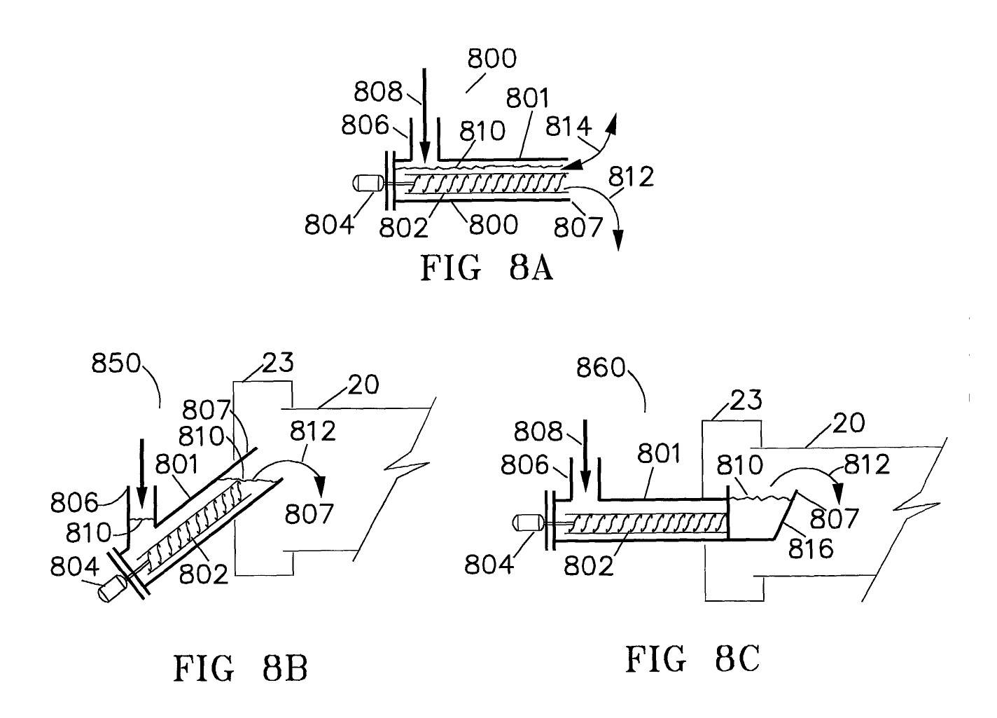

Screw conveyors of various configurations and arrangements may be successfully deployed in the present invention. Three such conveyors are shown in FIG. 8A-8C.

Referring first to FIG. 8A, conventionally arranged screw conveyor 800 is shown. FIG. 8A shows a screw conveyor 800 having a shell 801, a screw 802 with a screw drive 804 and a materials inlet 806. Solid material is fed to inlet 806 as indicated by arrow 808. The solid material is conveyed through the conveyor by screw 802 and is deposited out of the conveyor at discharge end 807 as indicated by arrow 812. However, because the solid material does not fill the conveyor, as indicated by level 810, vapors can flow in or out of the space between the screw 802 and the outside shell 801 of conveyor 800 as indicated by arrow 814.

Alternative screw conveyors shown in 8B and 8C are preferred for use in the present invention as each is arranged to provide a vapor seal preventing the flow of vapors in either direction through the screw conveyor as is desirable for use in the desorbtion drums and solid cooling drums previously described. Referring first to FIG. 8B, screw conveyor 850 is shown coupled to rotatable desorbtion drum 20 through non-rotatable inlet bulkhead 23. Screw conveyor 850 include an outer shell 801 and a screw 802 that is inclined such that the end nearest inlet 806 is lower than the discharge and 807. Solid material is fed into inlet 806 where it is conveyed via screw 802 toward discharge end 807. As shown, the solid material will fill the interior of shell 801 as indicated by level 810, thereby preventing the flow of vapors into or our of drum 20, the solids in shell 801 themselves providing the seal.

Referring to FIG. 8C, screw conveyor 860 again employs the solids themselves as a vapor barrier. As shown, conveyor 860 is connected to rotatable drum 20 and non-rotatable bulkhead 23. Solids are fed into inlet 806 and conveyed towards drum 20 by screw 802. Conveyor 860 includes a baffle 816. As solids are conveyed from inlet 806 toward discharge end 807, the solids impinge on baffle 816 causing a build up of solid material. As the screw conveyor continues to feed material towards discharge end 807, the level of solids near discharge end 807 will build to a level shown as 810. This mass of material at level 810 again prevents vapors from flowing into or out of drum 20 via screw conveyor 860. As solids are continued to be conveyed toward baffle 816, the level of solids 810 rises until the solid material spills over the top of baffle 816 and into drum 20; however, the level will remain high enough to cover the end of conveyor 802.

Reference is now made to FIG. 2 of the drawings, which is a schematic diagram of a second stage desorber apparatus in accordance with the present invention. The apparatus illustrated in FIG. 2 is similar to the apparatus in FIG. 1. For example, both have screw conveyors, rotating desorber drums sealed with bulkheads, heating means, and vapor recovery systems. The vapor recovery system as shown in FIG. 2, includes an attached eductor scrubber 150, cooling drum 152 and liquid accumulator 160. The apparatus shown in FIG. 2 operates in a similar manner to that described with reference to FIG. 1. Solid waste is fed to screw conveyor 126, introduced into desorber drum 120 through bulkhead 123. Drum 120 is heated externally by burner 127 or internally by hot gas 133 or both. Vapor is removed through eductor scrubber 150, cooling drum 152 and into accumulator 160. The solid waste is passed, after treatment, to the next stage though bulkhead 121 and line 142 in accordance with arrow 139. The remaining solids are then conveyed to the solids cooling apparatus shown in FIG. 5, previously described.

A two-stage desorbtion process will have additional advantages, over a single stage process. The preferred objective for a two-stage desorbtion process would be to remove as much volatile material as possible in the first stage without forming fine “entrainable” particles in the first stage, and to then remove the remaining volatile materials in the second stage. The temperatures selected for the desorber drum would depend on the factors previously mentioned, most importantly the composition of the waste material. For example, if the solid waste being treated begins to form fine entrainable particles between 800° F.-1000° F., the first stage drum 20 (FIG. 1) could be operated at the lower end, i.e., 800° F. or less. The second stage drum 120 (FIG. 2) would then operate at whatever temperature is necessary to remove the remaining hydrocarbons, typically between 800° F.-2000° F., depending on the desired liquid being removed from the waste feed. However, the operating temperature for the second stage drum 120 is usually less than 1550° F., on most waste material, so as to minimize the formation of carbon monoxide. Under these conditions, the first stage drum 20 (FIG. 1) would remove all but the heavy hydrocarbon material with very low amounts of particles being removed from the first stage desorber drum.

Referring still to FIG. 2, the attached eductor scrubber 150 helps remove particles that might become entrained in the small amount of vapors, providing relatively clean light-medium hydrocarbons. The vapor recovery system of FIG. 2 is operated in the same manner as the corresponding vapor recovery system previously described with reference to FIG. 1, with the exception that the temperatures for the cooling drum 152, accumulator 160 and line 167 of FIG. 2 may differ from the temperatures selected for the corresponding components in the stage one apparatus of FIG. 1. For example, accumulator 160 should be operated at a temperature lower than 212° F. if lower boiling point oil is to be recovered, and the driving liquid 157 should be oil, to maximize the recovery of hydrocarbons.

Measured by volume, water is generally the most significant component in the waste material treated in desorption processes. Using the two stage desorbtion process and apparatus of FIGS. 1 and 2, the amount of vapor created in stage two (FIG. 2) would be significantly less than that recovered in stage one (FIG. 1). In fact, the quantity of vapors recovered in stage two is typically 10 to 20 times less than the volume recovered in stage one under the conditions described for typical waste materials. A lower volume of vapor effluent corresponds to substantially fewer solids in the form of fine entrained particles leaving the solid waste stream and reaching accumulator 160. To prevent fouling, it is, of course, desirable to minimize the amount of entrained particles passing into accumulator 160.

In a two-stage desorption process as has been described with reference to FIGS. 1 and 2, a much smaller value of material is conveyed into the drum 120 of stage 2 as compared to that initially conveyed into drum 20 of stage one. Because of the substantial difference in the volume of the material being treated and vapor generated, drum 120 of stage 2 (FIG. 2) may be much smaller than drum 20 of stage 1 (FIG. 1). In addition, because drum 20 in a stage one apparatus would not be heated to the higher temperatures experienced by drum 120 in the second stage, drum 20 of stage 1 can be made from much less costly alloy, one that need not withstand the substantially higher temperatures of the stage 2 drums. The desorbtion drum typically represents a very large percentage of the cost of a complete desorbtion unit. Given that only the smaller drum 120 in stage two would require the more expensive alloy, a multiple stage desorbor such as shown in FIGS. 1 and 2 could provide substantial savings in capital cost.

A three-stage desorbtion process offers still further advantages and constitutes another preferred embodiment of the present invention. The basic principle and concepts are similar to the single and two stage apparatus and methods previously described. Such a three-stage desorbtion method and apparatus is collectively illustrated in FIGS. 1, 3, 4, and 5. The first, second and third stages are shown as FIGS. 1, 3, and 4 respectively. FIG. 5 again represents the cooling apparatus for the treated solids. Like a two-stage process, the drum temperatures would increase with each successive stage. That is, the temperature inside drum 20 (FIG. 1) would be less than the temperatures inside drum 220 (FIG. 3) which, in turn would be less than the temperature inside drum 320 (FIG. 4). The temperatures selected would ultimately be decided by various factors, such as waste composition, desired material to be recovered, economic factors, operator preference, etc. In the preferred embodiment, the first stage apparatus (FIG. 1) would be employed primarily to remove water, effectively acting as a dehydrator. The second stage apparatus (FIG. 3) would remove light to medium hydrocarbons, but would not reach temperatures capable of producing significant amounts of fine dust particles. The third stage (FIG. 4) should remove the heavier hydrocarbons.

The first stage apparatus (FIG. 1) would be configured as described above for the single or two stage process. The scrubber 50 would be optional for the first stage of a three stage description process but is believed beneficial and therefore preferred. The second stage (FIG. 3) has similar components to those described with reference to FIGS. 1 and 2 except that for the second stage of a three stage process, it is preferred that the vapor removing, cleaning, and condensing section or “vapor recovery section” be located near the outlet end of the desorber drum 220 rather than its inlet end. This is because in the three stage desorbtion process, the vapor recovery section of the second stage removes and treats not only vapor from the second stage, but also vapor recovered from the third stage, which is discussed further below. The basic operation at each stage is substantially the same as previously described with reference to FIG. 1, i.e., solid waste is introduced into the desorber drums, the drums are heated externally and/or internally, vapor is removed, and solid waste is passed to the next stage. As shown in FIGS. 3 and 4, the second stage desorber drum 220 passes waste to the third stage screw conveyor via line 242.

Referring now to FIG. 4, the waste material enters the third stage from line 242 moving along screw conveyor 326 and bulkhead 323 into drum 320 as indicted by arrow 336. Drum 320 is a rotatable desorber drum, similar to those described earlier, with bulkheads 323, 321 and corresponding seals 322, 324 at its ends. Drum 320 is heated by external lines 327 and/or internal hot gas supplied via line 333. The hot gas may be created by hot gas generator 330, or from exhaust gas, all as previously described.

As the waste is treated in third stage drum 320, the solid moves in accordance with arrow 338. The solids are then removed through line 342 along arrow 39 to the solids cooling apparatus of FIG. 5. The apparatus of FIG. 5 has the same function, design and operational settings for single and multiple stage desorbtion processes previously described.

In drum 320 of the third stage, only a small amount of vapor will be created because only heavy or high boiling point hydrocarbons should remain in the waste material by this stage. Given that very few vapors are generated in this third stage, fewer solid particles become entrained. Thus, a scrubber and accumulator are generally not required for stage three. Instead, the vapors removed during the third stage are preferably channeled through line 343 out of drum 320 and bulkhead 323 and back into the second stage apparatus at bulkhead 223, as shown in FIG. 3. The small amount of vapor generated from stage three is allowed to mix with the vapor effluent of stage two, and is drawn into scrubber 250 (FIG. 3) in accordance with arrow 237. The scrubber 250, cooling drum 252, and accumulator 260 are configured and operate in a similar manner as described with reference to in FIG. 2.

As mentioned previously, the temperature of each successive drum in a 3-stage desorbtion process would increase to vaporize the higher boiling point hydrocarbons. The temperatures employed will, of course, depend on the materials being processed and the desired products to be recovered. Typical temperature ranges for the three stages are as follows: stage one 250 to 600° F.; stage two 400 to 1000° F.; stage three 1000 to 1500° F. To withstand the higher temperatures, the alloy used to make the desorber drum in each successive stage would become more expensive. However, the volume of vapor created in the drums 20, 220, and 320 would decrease with each successive treatment. Accordingly, the waste material would occupy less volume with each stage, requiring less volume in each successive drum for treatment of the waste material. Thus, each successive desorber drum can be made smaller, so that the more expensive alloys need only be used for small desorber drums. A third stage drum would be substantially smaller than a first or second stage drum. For example, the second stage drum 220 may have a volume over 50% smaller than drum 20 of the first stage, and drum 320 may have a volume over 50% smaller than drum 220 of the second stage.

As mentioned previously, another cost saving measure is using the hot gas generation system to generate the heat needed for the desorber drums, or to convey hot exhaust gas into the drum to provide internal heating means. Each of these hot gas injection methods requires less energy to reach the desired drum temperatures than if only an exterior burner is employed. Also, the inside of the desorber drums can be insulated with an inner sleeve of a high temperature alloy material, while a standard, lower-priced steel skin is employed on the drum's outer sleeve or exterior. This construction, coupled with the smaller size for staged drums, can significantly reduce the capital costs of the desorbtion system.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A desorbtion method comprising:
(a) conveying waste material into a first drum, said first drum having a first gas extraction port;
(b) sealing the waste material in said first drum;
(c) heating the waste material in said first drum to a preselected first temperature sufficient to volatize at least one component of the waste material and form a gas;
(d) extracting the gas from said first drum through said first gas extraction port;
(e) conveying the waste material remaining after step (c) into a second drum, said second drum having a second gas extraction port;
(f) sealing the waste material in said second drum;
(g) heating the waste material in said second drum to a second temperature greater than said first temperature to volatize a component of the waste material and form a gas;
(h) extracting the gas from said second drum through said second gas extraction port.

2. The method of claim 1 further comprising:
(i) conveying the waste material remaining after step (h) into a third drum, said third drum having a third gas extraction port;
(j) sealing the waste material in said third drum;
(k) heating the waste material in said third drum to a third temperature greater than said second temperature to volatize a component of the waste material and form a gas;
(l) extracting the gas from said third drum through said third gas extraction port.

3. The method of claim 2 further comprising:
(m) conveying the waste material remaining after step (1) out of said third drum and into a solid cooling drum.

4. The method of claim 1 further comprising:
conveying the gas extracted from at least one of said drums into an eductor scrubber that is positioned adjacent to one of said gas extraction ports, said gas scrubber having a suction chamber.

5. The method of claim 1 wherein at least one of said gas extraction steps is accomplished by using an eductor scrubber attached to the gas extraction port of one of said drums.

6. The method of claim 2 further comprising:
conveying the gas extracted from said second and said third drums into an eductor scrubber that is positioned adjacent to said second gas extraction port.

7. The method of claim 4 further comprising:
cleaning said suction chamber by reciprocating a piston in said chamber.

8. The method of claim 1 wherein at least one of said heating steps comprises:
collecting exhaust gas generated by a burner apparatus;
conveying the collected exhaust gas into at least one of said drums.

9. The method of claim 1 wherein said first temperature is greater than 212 degrees F. and less than 650 degrees F.

10. The method of claim 9 wherein said second temperature is less than 1500 degrees F.

11. The method of claim 2 wherein only said third temperature is greater than 1000 degrees F.

12. A method for the recovery of selected materials from waste comprising:
(a) depositing waste material into a first drum, said first drum having a first internal volume and a first gas extraction port;
(b) sealing the waste material in said first drum;
(c) heating the waste material in said first drum to a temperature sufficient to volatize at least one component of the waste material and form a gas;
(d) extracting the gas from said first drum through said first gas extraction port;
(e) placing the waste material remaining after step (d) into a second drum, said second drum having a second gas extraction port and a second internal volume smaller than said first internal volume;
(f) sealing the waste material in said second drum;
(g) heating the waste material in said second drum to a temperature sufficient to volatize at least one component of the waste material and form a gas;
(h) extracting the gas from said second drum through said second gas extraction port.

13. The method of claim 12 further comprising:
(i) placing the waste material remaining after step (h) into a third drum, said third drum having a third gas extraction port and having a third internal volume that is less than said first internal volume;
(j) sealing the waste material in said third drum;
(k) heating the waste material in said third drum to a temperature sufficient to volatize at least one component of the waste material and form a gas;
(l) extracting the gas from said third drum through said third gas extraction port.

14. The method of claim 13 further comprising:
(m) removing the waste material remaining in said third drum after step (1) and placing it into a solid cooling drum.

15. The method of claim 13 wherein said third internal volume is less than said second internal volume.

16. The method of claim 12 wherein said second drum is heated to a higher temperature than said first drum.

17. The method of claim 13 wherein said third drum is heated to a higher temperature than said second drum and said second drum is heated to a higher temperature than said first drum.

18. The method of claim 12 further comprising:
conveying the gas extracted from at least one of said drums into an eductor scrubber that is positioned adjacent to one of said gas extraction ports, said gas scrubber having a suction chamber.

19. The method of claim 13 further comprising:
conveying the gas extracted from said second and said third drums into an eductor scrubber that is positioned adjacent to said second gas extraction port.

20. The method of claim 18 further comprising:
cleaning said suction chamber by reciprocating a piston in said chamber.

21. The method of claim 12 wherein at least one of said heating steps comprises:
collecting exhaust gas generated by a burner apparatus;
conveying the collected exhaust gas into at least one of said drums.

22. Apparatus for treating waste material and recovering selected products therefrom comprising:
a first drum having a first interior volume and a first gas extraction port;
a second drum having a second interior volume smaller than said first interior volume and having a second gas extraction port;
a heater heating the waste material in said first drum to a temperature and for a time sufficient to volatize at least one component of the waste material and form a gas of said component;
a conveyor for moving the waste material that is not volatized from said first drum to said second drum;
a heater heating the waste material in said second drum to a temperature and for a time sufficient to volatize at least one component of the waste material and form a gas of said component;
a conveyor for moving the waste material that is not volatized out of said second drum.

23. The apparatus of claim 22 wherein said first and second drum are made of different materials.

24. The apparatus of claim 23 wherein said second drum is made of a material that can withstand higher temperatures than the material of said first drum.

25. The apparatus of claim 22 wherein at least one of said drums includes an inner sleeve portion and an outer sleeve portion and wherein said inner sleeve portion is made of a material that can withstand higher temperatures than the material of said outer sleeve portion.

26. The apparatus of claim 22 further comprising:
a third drum having a third interior volume smaller than said first interior volume and having a third gas extraction port;
a heater heating the waste material in said third drum to a temperature and for a time sufficient to volatize at least one component of the waste material and form a gas of said component;
a conveyor for moving the waste material that is not volatized out of said third drum.

27. The apparatus of claim 26 wherein said third interior volume is less than said second interior volume.

28. The apparatus of claim 22 further comprising a conveyor for conveying waste material into at least one of said drums, said conveyor comprising a screw member disposed on an incline such that the end of said screw member closest to said drum is higher than the opposite end of said screw member.

29. The apparatus of claim 22 further comprising a conveyor for conveying waste material into at least one of said drums, said conveyor comprising:
a screw member having first and second ends;
an elongate shell housing said screw member;
a baffle attached to said shell and disposed at the end of said shell that is closest to said drum.

30. The apparatus of claim 22 wherein said heater comprises a burner apparatus generating an exhaust gas and wherein the waste material treating apparatus further comprises:
a stack collecting said exhaust gas;
a gas inlet in at least one of said drums;
conduit conveying the exhaust gas through said gas inlet and into said drum for heating the waste material.

31. The apparatus of claim 30 further comprising a hot gas generator conveying hot gas into at least one of said drums.

32. The apparatus of claim 22 further comprising an eductor scrubber that is positioned adjacent to one of said gas extraction ports, said eductor scrubber having a suction chamber with a given cross section.

33. The apparatus of claim 26 further comprising an eductor scrubber that is interconnected with said second and third gas extraction ports to receive gas from said second and said third drums, said eductor scrubber being positioned adjacent to said second gas extraction port of said second drum.

34. The apparatus of claim 32 further comprising a plunger disposed within said suction chamber of said eductor scrubber and movable between a first and a second position, said plunger having a shape congruent to said cross section of said suction chamber and having a side surface.

35. The apparatus of claim 34 wherein said side surface of said plunger includes teeth for scraping said suction chamber as said plunger moves between said first and said second positions.

36. Apparatus for treating waste material and recovering selected products therefrom comprising:
a rotatable desorbtion drum having first and second ends and a heating section there between;
a waste inlet in said drum for receiving waste material into said drum;
a heater heating the waste material in the heating section of said drum to a temperature and for a time sufficient to volatize at least one component of the waste material and form of gas;
a gas extraction port in said drum permitting a gas formed in the drum to be extracted from the drum;
an eductor scrubber having an inlet to a suction chamber positioned adjacent to said gas extraction port;
said eductor scrubber drawing the gas formed in said drum through said gas extraction port into said suction chamber.

37. The apparatus of claim 36 further comprising a plunger disposed within said suction chamber of said eductor scrubber and moveable between first and second positions, said plunger having a shape congruent to the cross-sectional shape of such suction chamber and having a side surface for scraping deposits from said suction chamber.

38. The apparatus of claim 36 were in said inlet of said suction chamber of said eductor scrubber is attached directly to said gas extraction port of said drum.

39. The apparatus of claim 36 wherein said heater comprises a burner apparatus generating an exhaust gas, and wherein the waste material treating apparatus further comprises:
a stack collecting the exhaust gas;
a gas inlet in at least one of said drums;
conduit conveying the exhaust gas through said gas inlet and into said drum for heating the waste material.

40. The apparatus of claim 36 wherein said heater comprises a hot gas generator generating a hot inert gas and wherein the waste treating apparatus further comprises:
a gas inlet in at least one of said drums;
conduit conveying the hot inert gas through said gas inlet and into said drum for heating the waste material.

41. A method for removing vapors generated in a desorbtion drum having a gas extraction port, the method comprising: positioning an eductor scrubber adjacent to said gas extraction port; and injecting a motive fluid into said eductor scrubber to draw vapors from the desorber drum into the eductor scrubber.

42. The method of claim 41 wherein said motive fluid is water.

43. The method of claim 42 further comprising cooling the vapors drawn into the eductor scrubber to a temperature below the boiling point of water to remove water from the vapors.

44. The method of claim 41 wherein said motive fluid is oil.

45. The method of claim 44 further comprising cooling the vapors drawn into the eductor scrubber to a temperature above the boiling point of water to remove oil, but not water, from the vapors.

46. A desorbtion method comprising:
(a) conveying waste material into a desorbtion drum, said drum having a gas extraction port;
(b) sealing said drum from the ambient atmosphere;
(c) conveying hot gas into said drum to heat the waste material to a preselected temperature sufficient to volatize at least one component of the waste material and form a vapor;
(d) extracting the vapor from said drum through said gas extraction port.

47. The method of claim 46 further comprising:
heating said drum using a burner apparatus;
collecting exhaust gas generated by said burner apparatus;
conveying the collected exhaust gas into said drum.

48. The method of claim 46 further comprising:
generating said hot gas in a hot gas generator;
conveying said hot gas from said hot gas generator to said drum;
wherein said hot gas contains substantially no oxygen.

49. The method of claim 48 further comprising:
heating said drum using a burner apparatus;
collecting exhaust gas generated by said burner apparatus;
conveying said collected exhaust gas into said drum.
